(19) United States
(12) Patent Application Publication
(10) Pub. No.: US 2020/0311157 A1
(43) Pub. Date: Oct. 1, 2020

(54) SYSTEM USER ATTRIBUTE DISAMBIGUATION BASED ON COHORT

(71) Applicants: Ye Yuan, Mountain View, CA (US); Girish Kathalagiri Somashekariah, Santa Clara, CA (US); Huichao Xue, Santa Clara, CA (US); Varun Mithal, Sunnyvale, CA (US); Ada Cheuk Ying Yu, Santa Clara, CA (US); Junrui Xu, Fremont, CA (US)

(72) Inventors: Ye Yuan, Mountain View, CA (US); Girish Kathalagiri Somashekariah, Santa Clara, CA (US); Huichao Xue, Santa Clara, CA (US); Varun Mithal, Sunnyvale, CA (US); Ada Cheuk Ying Yu, Santa Clara, CA (US); Junrui Xu, Fremont, CA (US)

(21) Appl. No.: 16/367,760

(22) Filed: Mar. 28, 2019

(51) Int. Cl. G06F 16/9535; G06N 5/04; G06F 16/9538; G06F 17/18; G06F 16/901; G06F 16/903

(52) U.S. Cl. CPC G06F 16/9535; G06N 5/04; G06F 16/90335; G06F 17/18; G06F 16/9024; G06F 16/9538

(57) ABSTRACT

In some embodiments, a computer system determines that online postings belong to a cohort based on the postings having an attribute of the cohort, identifies skills from the postings, determines that a user belongs to the cohort based on a determination that a profile of the user includes the attribute(s) of the cohort, determines that one or more of the skills is stored in association with the profile, determines a user confidence score that indicates a relevance level of the skill to the user for each one of the one or more of the skills, determines a cohort confidence score for each one of the one or more of the skills based on how many of the postings include the skill, and displays a recommendation associated based on a combination of the user confidence score and the cohort confidence score for at least a portion of the skills.

### TECHNICAL FIELD

The present application relates generally to systems, methods, and computer program products for using attribute-based cohorts for disambiguating data to improve computer functionality in generating recommendations of online content.

### BACKGROUND

Computer systems that generate recommendations of online content for users of an online service suffer from a lack of disambiguation of data, resulting in the most relevant content being downgraded in favor of irrelevant content in the display area, such as in a list of recommendations on a landing page or in a list of search results. As a result, users of such computer systems spend a longer time in their search or navigation for content and request the computer systems to perform actions with respect to the irrelevant content, leading to excessive consumption of electronic resources, such as a wasteful use of processing power and computational expense associated with generating and displaying irrelevant content, and a wasteful use of network bandwidth associated with navigating through the irrelevant content. Other technical problems may arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating a recommendation system, in accordance with an example embodiment.

FIG. 4 illustrates a graphical user interface (GUI) in which an online job posting is displayed, in accordance with an example embodiment.

FIG. 5 illustrates different pluralities of job postings assigned to corresponding cohorts, in accordance with an example embodiment.

FIG. 6 illustrates different job postings and their corresponding skills assigned to a particular cohort, in accordance with an example embodiment.

FIG. 7 illustrates a GUI in which a profile of a user is displayed, in accordance with an example embodiment.

FIG. 8A illustrates a table of user confidence scores for skills of a user of an online service, in accordance with an example embodiment.

FIG. 8B illustrates a table of combinations of user confidence scores and cohort confidence scores for skills of the user of the online service, in accordance with an example embodiment.

FIG. 9 is a flowchart illustrating a method of generating recommendations, in accordance with an example embodiment.

FIG. 10 is a flowchart illustrating another method of generating recommendations, in accordance with an example embodiment.

FIG. 11 is a flowchart illustrating yet another method of generating recommendations, in accordance with an example embodiment.

FIG. 12 is a block diagram illustrating a mobile device, in accordance with some example embodiments.

FIG. 13 is a block diagram of an example computer system on which methodologies described herein may be executed, in accordance with an example embodiment.

### DETAILED DESCRIPTION

### I. Overview

Example methods and systems of using attribute-based cohorts for disambiguating data to improve computer functionality in generating recommendations of online content are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above technical problems may be addressed by one or more example embodiments disclosed herein, which provide a system and method for using attribute-based cohorts for disambiguating data to improve computer functionality in generating recommendations of online content. In some example embodiments, a computer system determines appropriate cohorts for online content items (e.g., online job postings) based on attributes (e.g., position title, industry) of the online content items, and then, for each particular cohort, determines corresponding weights in the form of cohort confidence scores for features (e.g., skills) of the online content items that belong to that particular cohort based on the number of online content items in that particular cohort that include those features. These cohort confidence scores indicate the relevance or importance of each corresponding feature to their corresponding cohort. In some example embodiments, for a user who is determined by the computer system to belong to a particular cohort and have particular features, the computer system uses the corresponding cohort confidence scores of those features in conjunction with user confidence scores indicating the relevance or importance of each feature to the user in generating recommendations associated with the user, such as recommendations to be displayed to the user or recommendations about the user to be displayed to another user.

By performing these operations, the computer system of the present disclosure addresses problems of other computer systems. For example, in generating recommendations for online job postings for a user, other computer systems do not disambiguate between the skills of the user, thereby giving too much weight to certain skills even if those skills are not as relevant to the user's current situation. By adjusting the weights for skills based on how relevant or important those skills are to the user's current situation based on the cohort to which the user belongs, the computer system properly calibrates how the skills of the user should be weighted in generating recommendations associated with the user. Although example embodiments disclosed herein involve online content items that comprise online job postings and features that comprise skills, other types of online content items and features are also within the scope of the present disclosure.

The implementation of the features disclosed herein involves a non-generic, unconventional, and non-routine operation or combination of operations. By applying one or more of the solutions disclosed herein, some technical effects of the system and method of the present disclosure are to provide a specially configured computer system that avoids excessive consumption of electronic resources, conserving processing power, computational expense, and network bandwidth by using a specially-configured computer system to generate the most relevant online content item recommendations, as well as to reduce and minimize the consumption of electronic resources associated with providing such recommendations. As a result, the functioning of the computer system is improved. Other technical effects will be apparent from this disclosure as well.

### II. Detailed Example Embodiments

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

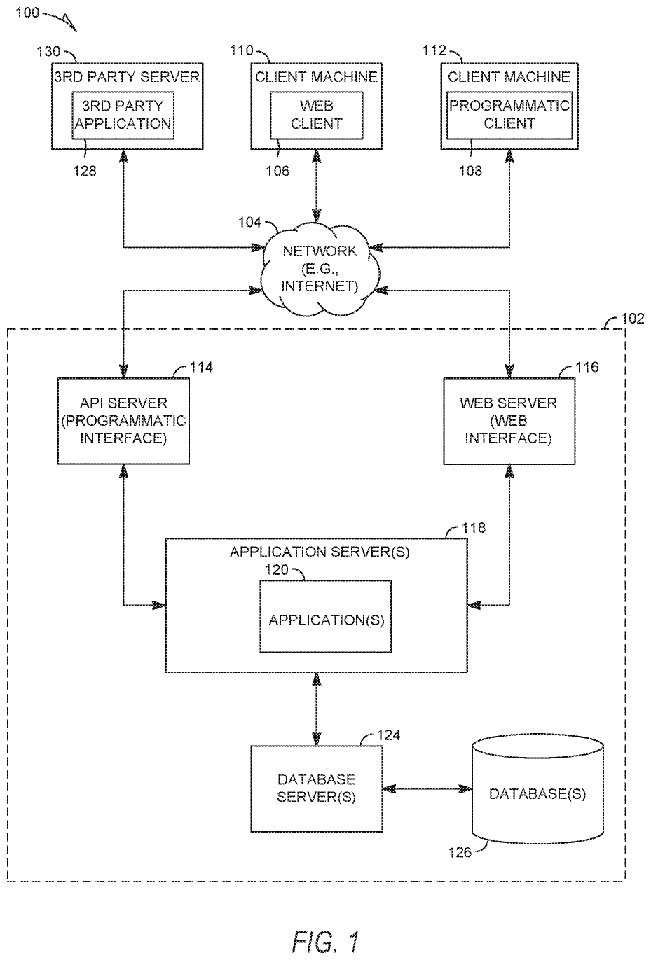

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

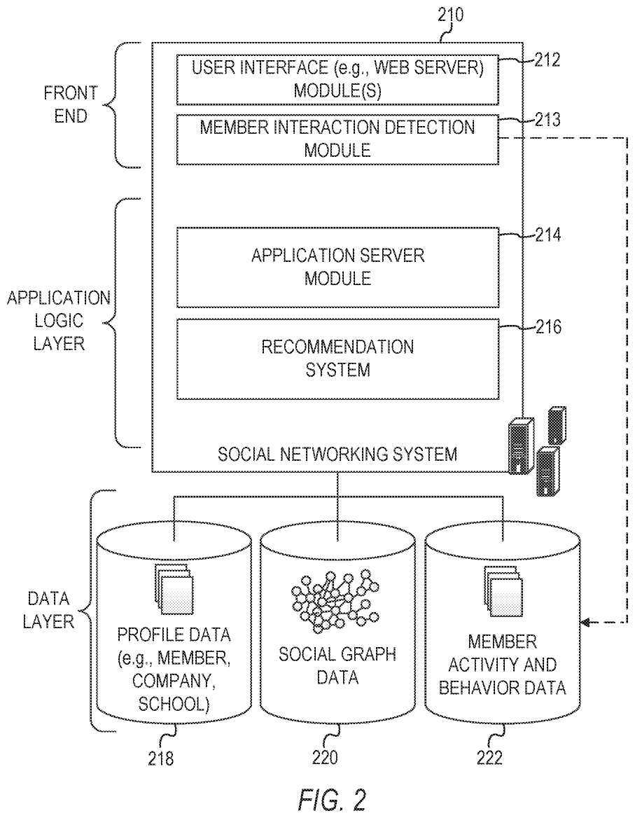

In some embodiments, the networked system 102 may comprise functional components of a social networking service. FIG. 2 is a block diagram showing the functional components of a social networking system 210, including a data processing module referred to herein as a recommendation system 216, for use in social networking system 210, consistent with some embodiments of the present disclosure. In some embodiments, the recommendation system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the recommendation system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream. In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the recommendation system 216. The members' interactions and behavior may also be tracked, stored, and used by the recommendation system 216 residing on a client device, such as within a browser of the client device, as will be discussed in further detail below.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the recommendation system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

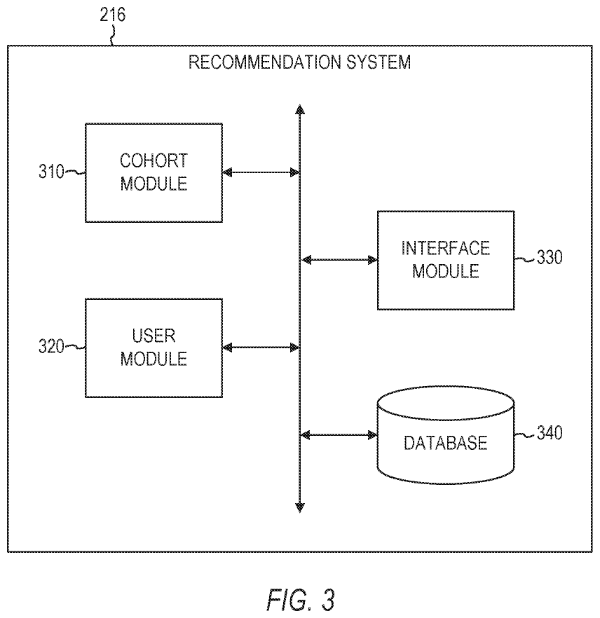

FIG. 3 is a block diagram illustrating components of the recommendation system 216, in accordance with an example embodiment. In some embodiments, the recommendation system 216 comprises any combination of one or more of a cohort module 310, a user module 320, an interface module 330, and one or more database(s) 340. The modules 310, 320, and 330, and the database(s) 340 can reside on a computer system, or other machine, having a memory and at least one processor (not shown). In some embodiments, the modules 310, 320, and 330, and the database(s) 340 can be incorporated into the application server(s) 118 in FIG. 1. In some example embodiments, the database(s) 340 is incorporated into database(s) 126 in FIG. 1 and can include any combination of one or more of databases 218, 220, and 222 in FIG. 2. However, it is contemplated that other configurations of the modules 310, 320, and 330, and the database(s) 340, are also within the scope of the present disclosure.

In some example embodiments, one or more of the modules 310, 320, and 330 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, and 330 is configured to receive user input. For example, one or more of the modules 310, 320, and 330 can present one or more GUI elements (e.g., drop-down menu, selectable buttons, text field) with which a user can submit input.

In some example embodiments, one or more of the modules 310, 320, and 330 is configured to perform various communication functions to facilitate the functionality described herein, such as by communicating with the social networking system 210 via the network 104 using a wired or wireless connection. Any combination of one or more of the modules 310, 320, and 330 may also provide various web services or functions, such as retrieving information from the third party servers 130 and the social networking system 210. Information retrieved by the any of the modules 310, 320, and 330 may include profile data corresponding to users and members of the social networking service of the social networking system 210.

Additionally, any combination of one or more of the modules 310, 320, and 330 can provide various data functionality, such as exchanging information with database(s) 340 or servers. For example, any of the modules 310, 320, and 330 can access member profiles that include profile data from the database(s) 340, as well as extract attributes and/or characteristics from the profile data of member profiles. Furthermore, the one or more of the modules 310, 320, and 330 can access social graph data and member activity and behavior data from database(s) 340, as well as exchange information with third party servers 130, client machines 110, 112, and other sources of information.

The cohort module 310 may determine, for each cohort, how important different skills are to that cohort. In some example embodiments, the cohort module 310 determines, for each cohort, that a corresponding plurality of online job postings published on an online service belong to the cohort based on the corresponding plurality of online job postings each having at least one particular attribute of the cohort. The attributes of the cohort may include, but are not limited to, a particular position title and a particular industry. In some example embodiments, each cohort is defined by at least two particular attributes. However, other defining attribute criteria for each cohort are also within the scope of the present disclosure.

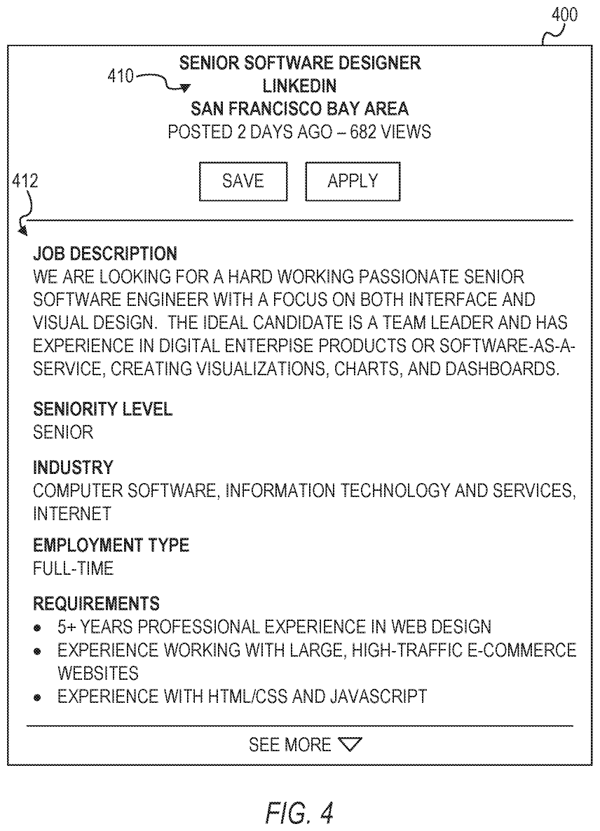

FIG. 4 illustrates a graphical user interface (GUI) 400 in which an online job posting is displayed, in accordance with an example embodiment. In FIG. 4, the job posting comprises headline information 410 and detailed information 412. The headline information 410 comprises basic information about the job posting, such as the job title or position (e.g., “SENIOR SOFTWARE DESIGNER”), the name of the company or organization seeking applicants for the job title or position (e.g., “LINKEDIN”), and the location of the job (e.g., “SAN FRANCISCO BAY AREA”). The detailed information 412 comprises more detailed information about the job, including, but not limited to, a job description, a seniority level of the job, one or more industries to which the job corresponds, an employment type for the job, and requirements for the job. The cohort module 310 may retrieve the attribute data (e.g., position title and industry) and skills for the job posting from a database in which the attribute data and skills are stored as structured data, or may parse the published job posting to extract the relevant attribute data and skills.

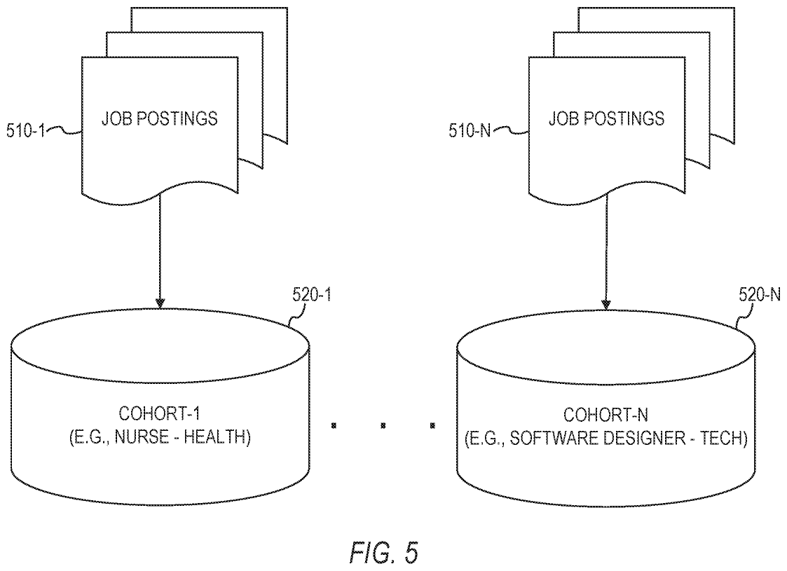

FIG. 5 illustrates different pluralities of job postings 510 (e.g., a first plurality of job postings 510-1, . . . , an Nth plurality of job postings 510-N) assigned to corresponding cohorts 520 (e.g., cohort 520-1, . . . , cohort 520-N), in accordance with an example embodiment. In the example embodiment shown in FIG. 5, each cohort 520 has its own defining attribute criteria. For example, the plurality of job postings 510-1 are determined to belong to the cohort 520-1 based on each one of the plurality of job postings 510-1 having a position title attribute of “NURSE” and an industry attribute of “HEALTH,” and the plurality of job postings 510-N are determined to belong to the cohort 520-N based on each one of the plurality of job postings 510-N having a position title attribute of “SOFTWARE DESIGNER” and an industry attribute of “TECH.” Other configurations of defining attribute criteria are also within the scope of the present disclosure.

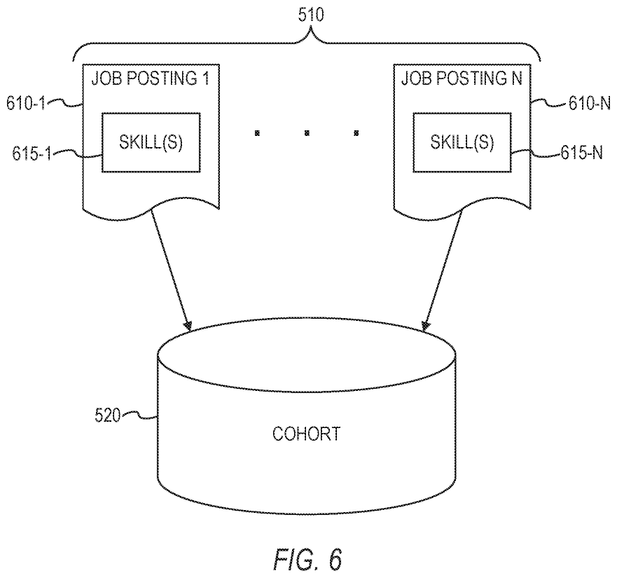

Referring back to FIG. 3, in some example embodiments, the cohort module 310 is configured to, for each plurality of online job postings, identify a plurality of skills from the plurality of online job postings. FIG. 6 illustrates different job postings 610 and their corresponding skills 615 assigned to a particular cohort 520, in accordance with an example embodiment. In FIG. 6, the plurality of job listings 510 for a single cohort 520 from FIG. 5 is made up of individual job postings 610 (e.g., job posting 610-1, . . . , job posting 610-N). Each job posting 610 has a one or more skills 615 associated with it (e.g., one or more skills included in the job listing). For example, job posting 610-1 has one or more skills 615-1, and job posting 610-N has one or more skills 615-N. The skills 615 for different job postings 610 may overlap. For example, job posting 610-1 may have one or more of the same skills 615 as job posting 610-N.

In some example embodiments, the cohort module 310 determines, for each skill 615 of the cohort 520 (e.g., for each skill 615 included in a job posting 610 that belongs to the cohort 520), how many job postings 615 of the cohort 520 include the skill 615. The cohort module 310 may determine, for each one of the skills 615, a corresponding cohort confidence score based on the corresponding number of the job postings 610 of the cohort 520 in which the skill 615 is included, thereby determining a score that indicates how important that particular skill 615 is to that particular cohort 520. For example, if there are one-hundred job postings 610 that belong to a particular cohort 520, and fifty-three of those one-hundred job postings 610 of the cohort 520 have “Java” as a skill 615, and only three of those one-hundred job postings 610 of the cohort 520 have “SQL” as a skill 615, then the cohort module 310 may determine corresponding cohort confidence scores for the “Java” skill 615 and the “SQL” skill 615 that indicate that the “Java” skill 615 is more important to the cohort 520 than the “SQL” skill 615, since the “Java” skill 615 is associated with more job postings 610 of the cohort 520 than the “SQL” skill 615. The cohort confidence scores for the skills 615 may be stored in the database 340 of the online service for subsequent retrieval and use in generating recommendations.

Referring back to FIG. 3, in some example embodiments, the user module 320 is configured to determine the specific cohort 520 to which a particular user belongs based on profile data of the user. For example, the user module 320 may determine that the user belongs to a specific cohort 520 based on a determination that a profile of the user stored in a database of the online service includes the defining attribute criteria of that specific cohort 520. In some example embodiments, the user module 320 accesses profile data of the user stored in the database 218 of FIG. 2 to determine the current attribute data of the user that is relevant to the defining attribute criteria of the different cohorts 520 to determine to which specific cohort 520 the user belongs. For example, the user module 320 may retrieve the user's current position title and industry from the user's profile data and compare it to the position title and industry of a specific cohort 520 to see if this retrieved attribute data of the user matches or is determined to be sufficiently similar to (e.g., determined to be a synonym for) the defining attribute criteria of the specific cohort 520. Using the example embodiment shown in FIG. 5, the user module 320 may determine whether the profile data of a user indicates that the user is currently a nurse in the health industry in order to determine whether the user belongs to the cohort 520-1, which has defining attribute criteria comprising a position title attribute of “NURSE” and an industry attribute of “HEALTH.”

In some example embodiments, the user module 320 is configured to determine that one or more skills 615 of a particular cohort 520 to which the user belongs is stored in association with the profile of the user, such as in the database 218 in FIG. 2, and, for each one of those skills 615, determine a corresponding user confidence score that indicates a level of relevance or importance of the skill 615 to the user. The user module 320 may determine the level of relevance or importance of the skill 615 to the user, and consequently the corresponding user confidence score for the skill 615, by analyzing the profile of the user, such as by using natural language processing or by accessing stored input explicitly provided by the user that indicates the level of relevance of importance of the skill 615. The user module 320 may generate the corresponding user confidence score for each one of the one or more of the plurality of skills based on the analyzing of the profile of the user, and then store the corresponding user confidence score for each skill 615 in the database 340 of the online service in association with the profile of the user for subsequent retrieval and use in generating recommendations.

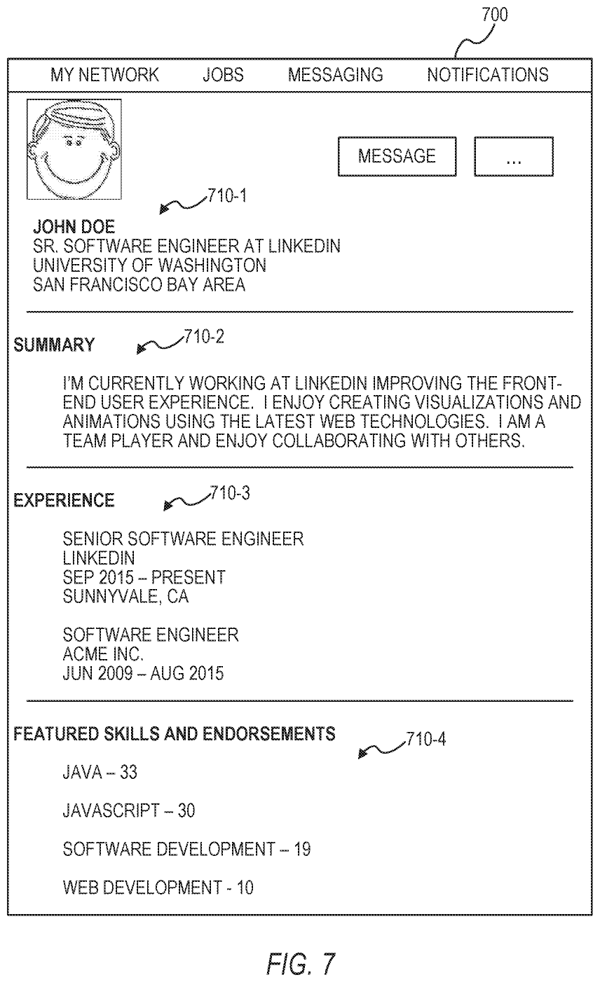

FIG. 7 illustrates a GUI 700 in which a profile of a user is displayed, in accordance with an example embodiment. The profile page displayed in the GUI 700 comprises profile data 710 of the user. In the example shown in FIG. 4, the profile data 710 includes headline data 710-1 identifying the user (e.g., photo and name), the user's current position at a particular organization, the user's current industry (not shown), and the user's current residential location, summary data 710-2, experience data 710-3, and featured skill and endorsement data 710-4 that identifies skills of the user along with a number of endorsements from other users for the skills of the user. Other types of profile data 710 are also within the scope of the present disclosure. In some example embodiments, the GUI 700 displays each type of profile data 710 in its own dedicated section of profile page.

In some example embodiments, the interface module 330 is configured to cause one or more recommendations associated with the user to be displayed within a user interface on a computing device. The recommendations may include, but are not limited to, recommendations of job opening for the user, recommendations of online courses for the user, and recommendations of the user as a candidate for a job opening to a recruiter for the job opening. Other types of recommendations are also within the scope of the present disclosure.

In some example embodiments, the interface module 330 uses a scoring model to generate scores for online content (e.g., job postings, online courses, job candidates) that is being considered for recommendation. The scoring model may comprise a generalized linear mixed model that comprises a baseline model (e.g., a global model), a user-based model, and an item-based model. The baseline model is a fixed effects model, whereas the user-based model and the item-based model are random effects models. A fixed effects model is a statistical model in which the model parameters are fixed or non-random quantities. A fixed effects model may comprise a regression model in which the group means are fixed (non-random) as opposed to a random effects model in which the group means are a random sample from a population. Generally, data can be grouped according to several observed factors. The group means could be modeled as fixed or random effects for each grouping. In a fixed effects model, each group mean is a group-specific fixed quantity.

In some example embodiments, the baseline model is a generalized linear model based on feature data of the candidate online content items. A generalized linear model is a flexible generalization of ordinary linear regression that allows for response variables that have error distribution models other than a normal distribution. The generalized linear model generalizes linear regression by allowing the linear model to be related to the response variable via a link function and by allowing the magnitude of the variance of each measurement to be a function of its predicted value.

In some example embodiments, the feature data of the candidate online content items comprises one or more of at least one skill, at least one interest, at least one industry, at least one employment history data, and at least one educational background data (e.g., skills listed in a job posting). However, other types of feature data are also within the scope of the present disclosure. The feature data may be stored in and accessed by the interface module 330 from the database 340.

In some example embodiments, the generalized linear model of the baseline model is further based on a comparison of profile information of the user with the feature data of the online content item, such as the feature data of the job posting. Such configuration of the generalized linear model may be used in use cases where recommendations for online content items are being generated for display on a landing page of an online service or in an electronic message from the online service to the user (e.g., a text message or an e-mail). In some example embodiments, the profile information comprises one or more of at least one of skill, at least one interest, at least one industry, at least one employment history data, and at least one educational background data. However, other types of profile information are also within the scope of the present disclosure, including, but not limited to, any profile data stored in the database 218 in FIG. 2. In some example embodiments, the interface module 330 is configured to extract profile information from a profile of the target user stored in the database 218. In some example embodiments, the generalized linear model of the baseline model is further based on a comparison of a search query received from the user with the feature data of the online content item. Such configuration of the generalized linear model may be used in use cases where recommendations for online content items are being generated for display as part of search results in response to the search query.

In some example embodiments, the user-based model of the generalized linear mixed model is a random effects model based on a history of online user actions by the user directed towards reference online content items having feature data determined to be related to the feature data of the online content item being scored. A random effects model, also called a variance components model, is a statistical model where the model parameters are random variables. The random effects model is a kind of hierarchical linear model, which assumes that the data being analyzed are drawn from a hierarchy of different populations whose differences relate to that hierarchy. In some example embodiments, the online user actions directed towards the reference online content items comprise at least one of selecting a user interface element indicating an interest by the user in viewing the reference online content items, selecting a user interface element indicating an interest by the user in saving the reference online content items, and selecting a user interface element indicating an interest by the user in sending a message corresponding to the reference online content items. It is contemplated that other types of online user actions are also within the scope of the present disclosure. The history of online user actions may be stored in and accessed by the interface module 330 from the database 222 in FIG. 2.

In some example embodiments, the item-based model is a random effects model based on a history of online user actions directed towards the online content item being scored by a plurality of reference users having profile information determined to be related to the profile information of the user for which the recommendation score is being generated. The online user actions directed towards the online content item may comprise at least one of selecting a user interface element indicating an interest by the reference users in viewing the candidate online content item, selecting a user interface element indicating an interest by the reference users in saving the candidate online content item, and selecting a user interface element indicating an interest by the user in sending a message corresponding to the reference online content item. It is contemplated that other types of online user actions are also within the scope of the present disclosure. The history of online user actions may be stored in and accessed by the interface module 330 from the database 222 in FIG. 2.

In some example embodiments, the interface module 330 is configured to, for a plurality of potential recommendations of online content items (e.g., job postings) for a user, calculate a corresponding recommendation score the potential recommendation based on the skills of the user using a combination of the corresponding user confidence score and cohort confidence score for each skill of the user. The interface module 330 may then select a portion of the potential recommendations for display based on their corresponding recommendation scores, which are based on the corresponding combinations of the corresponding user confidence score and corresponding cohort confidence score. For example, the interface module 330 may rank the potential recommendations based on their recommendation scores, and then select a portion of the potential recommendations based on their ranking (e.g., the top N ranked recommendations).

In some example embodiments, the corresponding combination of the corresponding user confidence score and the corresponding cohort confidence score for each one of the skills comprises a corresponding multiplication product of the corresponding user confidence score and the corresponding cohort confidence score. For example, if the user confidence score for a skill is 0.8 and the cohort confidence score for the skill is 0.5, then then combination may comprise a multiplication product of 0.4 (0.8×0.5=0.4), thereby decreasing the importance of the skill from what the user confidence score was based on the cohort confidence score.

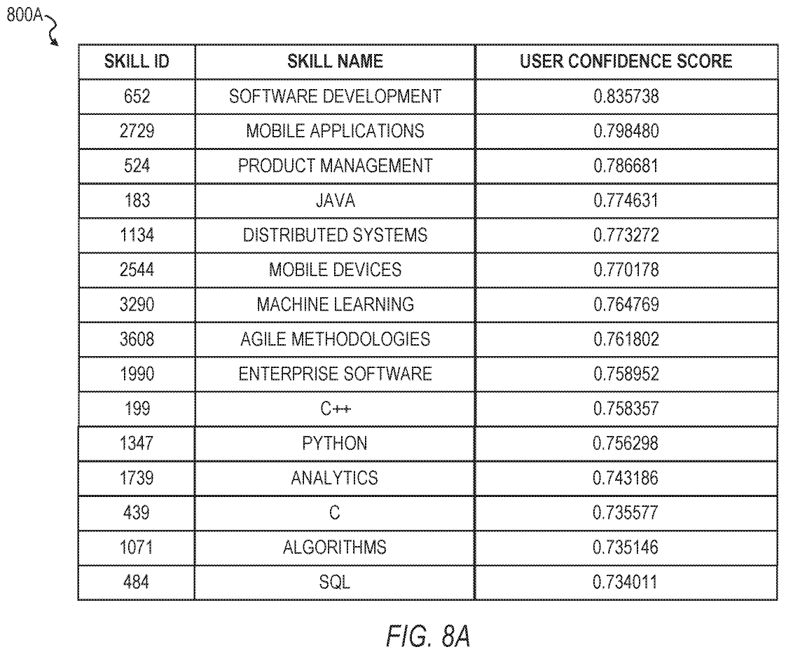

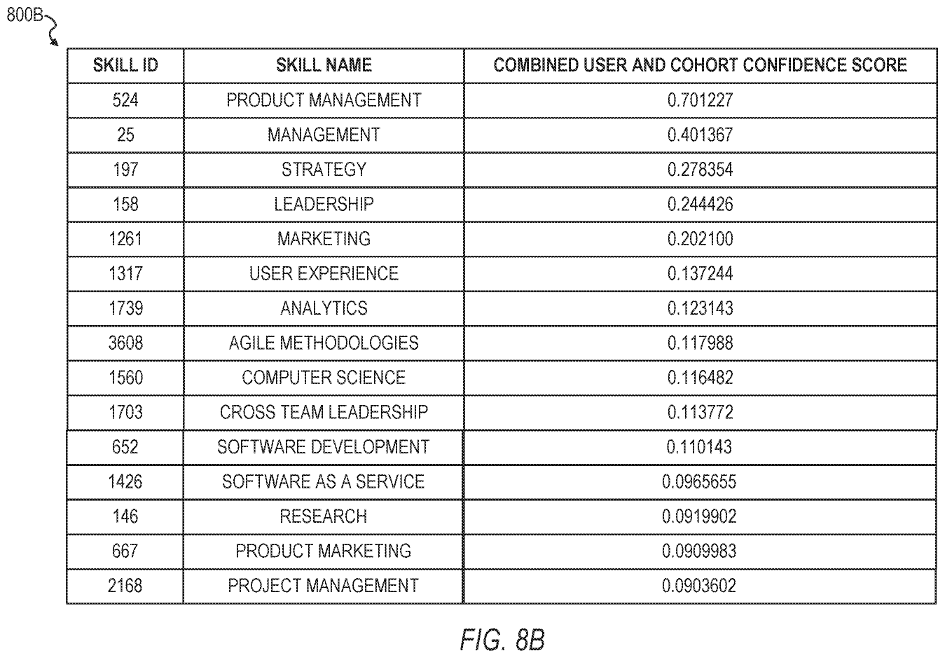

FIG. 8A illustrates a table 800A of user confidence scores for skills 615 of a user of an online service, in accordance with an example embodiment. In FIG. 8A, the table 800A comprises a corresponding user confidence score for different skills 615. The skills 615 are represented in the table 800A with corresponding skill identifiers (ID's) and skill names. The user confidence scores in the table 800A are numerical scores between 0.00 and 1.00. However, other forms of user confidence scores are also within the scope of the present disclosure.

FIG. 8B illustrates a table 800B of combinations of user confidence scores and cohort confidence scores for skills 615 of the user of the online service, in accordance with an example embodiment. The skills 615 are represented in the table 800B with corresponding skill identifiers (ID's) and skill names. The combined scores in the table 800B are numerical scores between 0.00 and 1.00. However, other forms of the combined scores are also within the scope of the present disclosure. The combined scores represent adjustments to the corresponding user confidence scores in the table 800A of FIG. 8A with the cohort confidence scores. For example, each combined score may comprise a corresponding multiplication product of the corresponding user confidence score and the corresponding cohort confidence score. The adjustments of the user confidence scores with the cohort confidence scores are made in order to take into account the number of job postings 610 of the cohort 520 that include the corresponding skill 615 (e.g., a percentage of the job postings 610 of the cohort 520 that include the corresponding skill 615). The adjustments to the corresponding user confidence scores result in a more accurate representation of the relevance or importance of the corresponding skill 615 for the purposes of generating recommendation scores used to determine which job postings or other online content to display in the form of recommendations.

In some example embodiments, the interface module 330 is configured to use the combined scores of the skills 615 as a basis for filtering out certain skills 615 from the calculation of the recommendations score. Since the number of skills for a user may be quite large, plugging each and every skill for each and every user into the scoring model used by the interface module 330 to generate corresponding recommendations scores for job postings or other online content is computationally expensive and results in excessive consumption of the electronic resources of the computer system. In order to address this technical problem, in some example embodiments, the interface module 330 only uses the skills 615 having combined confidence scores that satisfy (e.g., that meet or are above) a predetermined threshold value in the calculation of recommendation scores for a user, while omitting from the calculation of recommendation scores any skills that have combined confidence scores that do not satisfy (e.g., are below) the predetermined threshold value.

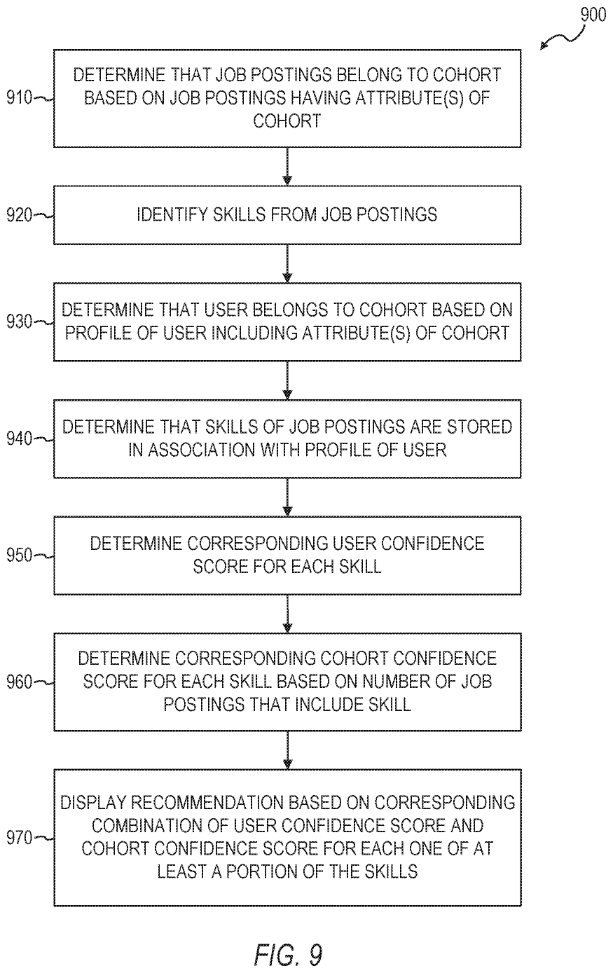

FIG. 9 is a flowchart illustrating a method 900 of generating recommendations, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the recommendation system 216 of FIGS. 2-3, or any combination of one or more of its modules, as described above.

At operation 910, the recommendation system 216 determines that a plurality of online job postings published on an online service belong to a cohort based on the plurality of online job postings each having at least one particular attribute of the cohort. In some example embodiments, the at least one particular attribute of the cohort comprises at least two particular attributes. In some example embodiments, the at least two particular attributes of the cohort comprise a particular position title and a particular industry. However, other types and configurations of defining attribute criteria for the cohort are also within the scope of the present disclosure.

At operation 920, the recommendation system 216 identifies a plurality of skills from the plurality of online job postings. In some example embodiments, each one of the plurality of skills is included in at least one of the plurality of online job postings. The same skill may be included in more than one of the online job postings in the plurality of online job postings.

At operation 930, the recommendation system 216 determines that a user of the online service belongs to the cohort based on a determination that a profile of the user stored in a database of the online service includes the defining attribute(s) of the cohort. This determination may be made by accessing profile data of the user and comparing the accessed profile data with the defining attribute(s) of the cohort to determine whether the profile data comprises the defining attribute(s) either as a match or a synonym.

At operation 940, the recommendation system 216 determines that one or more of the plurality of skills is stored in association with the profile of the user in the database of the online service. This determination may be made by accessing the profile data of the user and comparing the accessed profile data with the skills of the cohort to determine whether the profile data comprises matching or sufficiently similar skills as the skills of the cohort.

At operation 950, the recommendation system 216, for each one of the one or more of the plurality of skills determined at operation 940, determines a corresponding user confidence score that indicates a level of relevance of the skill to the user. The recommendation system 216 may determine the level of relevance or importance of the skill to the user, and consequently the corresponding user confidence score for the skill, by analyzing the profile of the user, such as by using natural language processing, or by accessing stored input explicitly provided by the user that indicates the level of relevance of importance of the skill. In some example embodiments, the determining the corresponding user confidence score for each one of the one or more of the plurality of skills comprises retrieving the corresponding user confidence score for each one of the one or more of the plurality of skills from the database of the online service.

At operation 960, the recommendation system 216, for each one of the one or more of the plurality of skills, determines a corresponding cohort confidence score based on a corresponding number of the plurality of online job postings in which the skill is included, which indicates how important that particular skill is to that particular cohort. The cohort confidence scores for the skills may be calculated in real-time or retrieved from the database 340.

At operation 970, the recommendation system 216 causes a recommendation associated with the user to be displayed within a user interface on a computing device based on a corresponding combination of the corresponding user confidence score and the corresponding cohort confidence score for each one of at least a portion of the one or more of the plurality of skills. In some example embodiments, the corresponding combination of the corresponding user confidence score and the corresponding cohort confidence score for each one of the at least a portion of the one or more of the plurality of skills comprises a corresponding multiplication product of the corresponding user confidence score and the corresponding cohort confidence score. In some example embodiments, the causing the recommendation to be displayed comprises calculating a recommendation score for the recommendation based on the corresponding combination for each one of the at least a portion of the one or more of the plurality of skills, with a remaining portion of the one or more of the plurality of skills other than the at least a portion of the one or more of the plurality of skills being omitted from the calculating of the recommendation score based on the corresponding combination for each skill in the remaining portion not satisfying a threshold value.

In some example embodiments, the recommendation comprises a job recommendation of another online job posting published on the online service, the causing the recommendation to be displayed comprises determining that the other online job posting belongs to the cohort based on the other online job posting having the at least one particular attribute of the cohort, and the job recommendation is caused to be displayed on a computing device of the user based on the corresponding combination of the corresponding user confidence score and the corresponding cohort confidence score for each one of the at least a portion of the one or more of the plurality of skills. The corresponding cohort confidence scores may be used in the corresponding combinations based on the determining that the other online job posting belongs to the cohort.

In some example embodiments, the recommendation comprises a course recommendation of an online course published on the online service, the causing the recommendation to be displayed comprises determining that the online course belongs to the cohort based on the online course having the at least one particular attribute of the cohort, and the course recommendation is caused to be displayed on a computing device of the user based on the corresponding combination of the corresponding user confidence score and the corresponding cohort confidence score for each one of the at least a portion of the one or more of the plurality of skills. The corresponding cohort confidence scores may be used in the corresponding combinations based on the determining that the online course belongs to the cohort.

In some example embodiments, the recommendation comprises a candidate recommendation for another online job posting published on the online service, the causing the recommendation to be displayed comprises determining that the other online job posting belongs to the cohort based on the other online job posting having the at least one particular attribute of the cohort, and the candidate recommendation is caused to be displayed on a computing device of a recruiter for the other online job posting based on the corresponding combination of the corresponding user confidence score and the corresponding cohort confidence score for each one of the at least a portion of the one or more of the plurality of skills. The corresponding cohort confidence scores may be used in the corresponding combinations based on the determining that the other online job posting belongs to the cohort.

It is contemplated that any of the other features described within the present disclosure can be incorporated into the method 900.

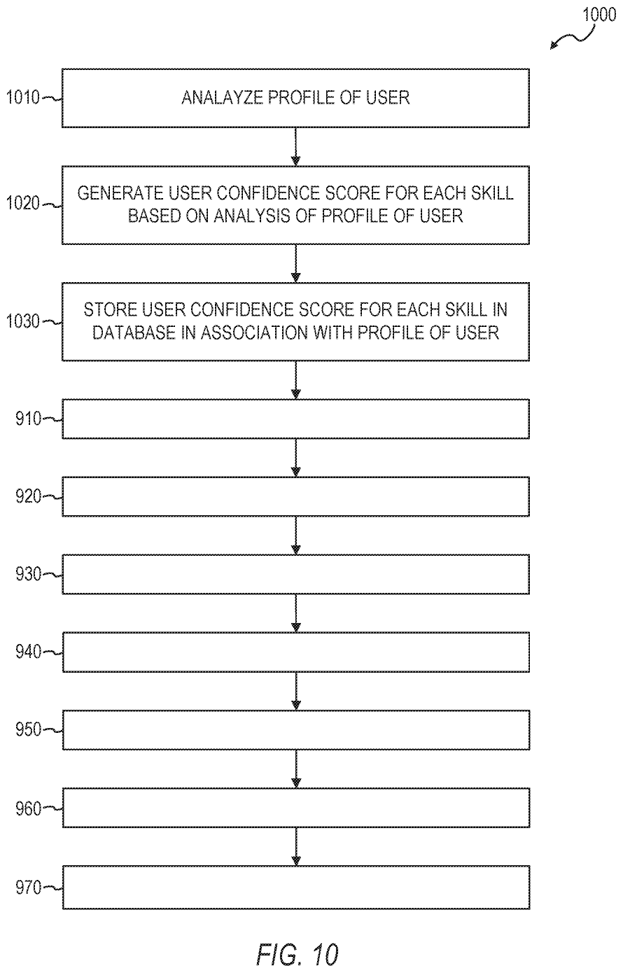

FIG. 10 is a flowchart illustrating another method 1000 of generating recommendations, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the recommendation system 216 of FIGS. 2-3, or any combination of one or more of its modules, as described above. In some example embodiments, the method 1000 comprises operations 1010, 1020, and 1030, which are performed prior to the performance of operations 910, 920, 930, 940, 950, 960, and 970 of the method 900 in FIG. 9.

At operation 1010, the recommendation system 216 analyzes the profile of the user. In some example embodiments, this analysis comprises performing natural language processing to determine how important each skill in the profile of the user is to the user. In some example embodiments, this analysis comprises accessing explicit input entered by the user to indicate the level of importance of the skill.

At operation 1020, the recommendation system 216 generates the corresponding user confidence score for each of one or more of the plurality of skills based on the analyzing of the profile of the user. In some example embodiments, the user confidence scores comprise numerical scores between 0.00 and 1.00. However, other forms of the user confidence scores are also within the scope of the present disclosure.

At operation 1030, the recommendation system 216 stores the corresponding user confidence score for each one of the one or more of the plurality of skills in the database of the online service in association with the profile of the user. In some example embodiments, the user confidence scores are subsequently retrieved for use in generating recommendations associated with the user.

It is contemplated that any of the other features described within the present disclosure can be incorporated into the method 1000.

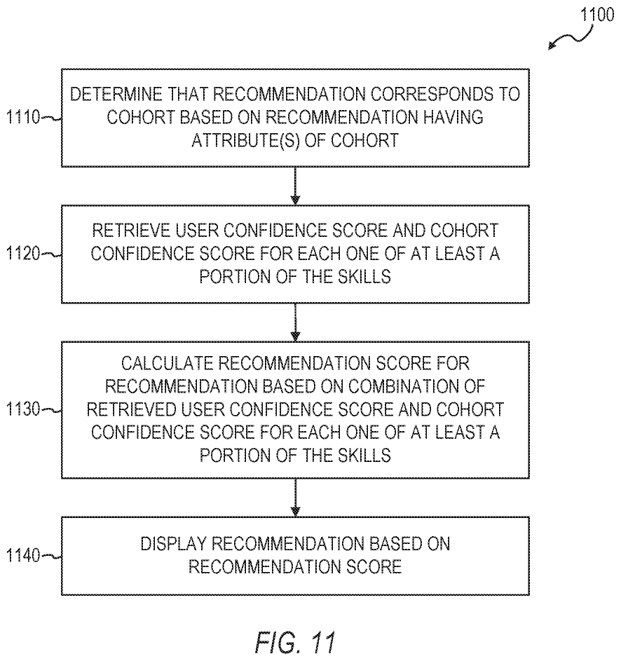

FIG. 11 is a flowchart illustrating yet another method 1100 of generating recommendations, in accordance with an example embodiment. The method 1100 can be performed by processing logic that can comprise hardware (e.g., circuitry, dedicated logic, programmable logic, microcode, etc.), software (e.g., instructions run on a processing device), or a combination thereof. In one implementation, the method 1100 is performed by the recommendation system 216 of FIGS. 2-3, or any combination of one or more of its modules, as described above. In some example embodiments, the method 1100 comprises operations 1110, 1120, 1130, and 1140, which may be performed as part of operation 970 of the method 900 in FIG. 9. In some example embodiments, the corresponding user confidence score and the corresponding cohort confidence score for each one of at least a portion of the skills is stored in association with the profile of the user in the database of the online service.

At operation 1110, the recommendation system 216 determines that a recommendation associated with a user corresponds to a cohort based on the recommendation having the attribute(s) of the defining attribute criteria of the cohort. In some example embodiments, the recommendation comprises a job recommendation of an online job posting published on the online service, a course recommendation of an online course published on the online service, or a candidate recommendation for another online job posting published on the online service. However, other types of recommendations are also within the scope of the present disclosure.

At operation 1120, the recommendation system 216 retrieves the corresponding user confidence score and the corresponding cohort confidence score for each one of the skills of the user that also corresponds to the recommendation (e.g., the job posting of the recommendation, the online course of the recommendation, the user job candidate of the recommendation) based on the determining that the recommendation corresponds to the cohort at operation 1110. The user confidence scores and the cohort confidence scores may be retrieved from the database 340.

At operation 1130, the recommendation system 216 calculates a recommendation score for the recommendation based on the corresponding combination of the retrieved corresponding user confidence score and the retrieved corresponding cohort confidence score for each one of the at least a portion of the one or more of the plurality of skills. In some example embodiments, the recommendation system 216 may use a generalized linear mixed model to calculate the recommendations score, as previously discussed. However, other models may be used, and other ways of calculating the recommendation score are also within the scope of the present disclosure.

At operation 1140, the recommendation system 216 causes the recommendation to be displayed based on the recommendation score of the recommendation. In some example embodiments, the recommendation may be displayed based on its recommendation score satisfying a threshold value. In some example embodiments, the recommendation may be displayed based on its position in a ranking of recommendations based on their recommendation scores. In some example embodiments where the recommendation comprises a recommendation of a job posting or a recommendation of an online course, the recommendation is displayed on the computing device of the user. In some example embodiments where the recommendation comprises a recommendation of the user as a candidate for a job posting, the recommendation is displayed on a computing device of another user who is associated with the job posting, such as a recruiter for the job posting.

It is contemplated that any of the other features described within the present disclosure can be incorporated into the method 1100.

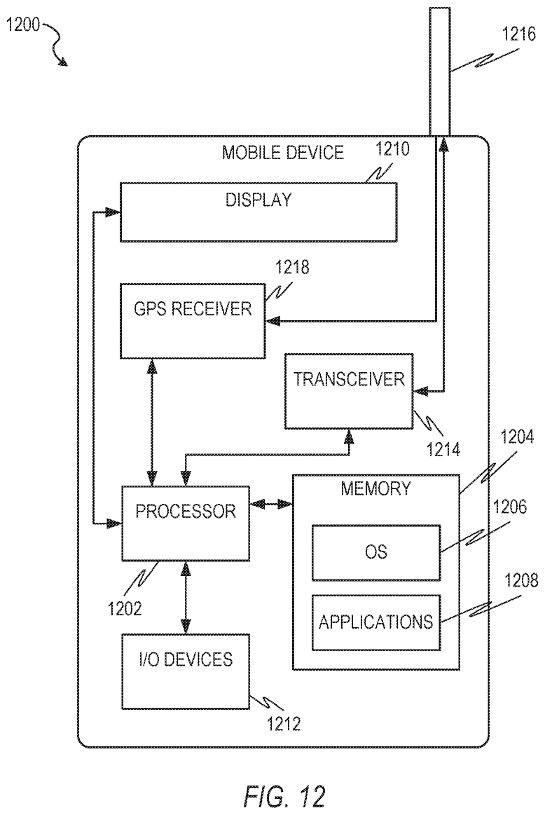

FIG. 12 is a block diagram illustrating a mobile device 1200, according to an example embodiment. The mobile device 1200 can include a processor 1202. The processor 1202 can be any of a variety of different types of commercially available processors suitable for mobile devices 1200 (for example, an XScale architecture microprocessor, a Microprocessor without Interlocked Pipeline Stages (MIPS) architecture processor, or another type of processor). A memory 1204, such as a random access memory (RAM), a Flash memory, or other type of memory, is typically accessible to the processor 1202. The memory 1204 can be adapted to store an operating system (OS) 1206, as well as application programs 1208, such as a mobile location-enabled application that can provide location-based services (LBSs) to a user. The processor 1202 can be coupled, either directly or via appropriate intermediary hardware, to a display 1210 and to one or more input/output (I/O) devices 1212, such as a keypad, a touch panel sensor, a microphone, and the like. Similarly, in some embodiments, the processor 1202 can be coupled to a transceiver 1214 that interfaces with an antenna 1216. The transceiver 1214 can be configured to both transmit and receive cellular network signals, wireless data signals, or other types of signals via the antenna 1216, depending on the nature of the mobile device 1200. Further, in some configurations, a GPS receiver 1218 can also make use of the antenna 1216 to receive GPS signals.

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

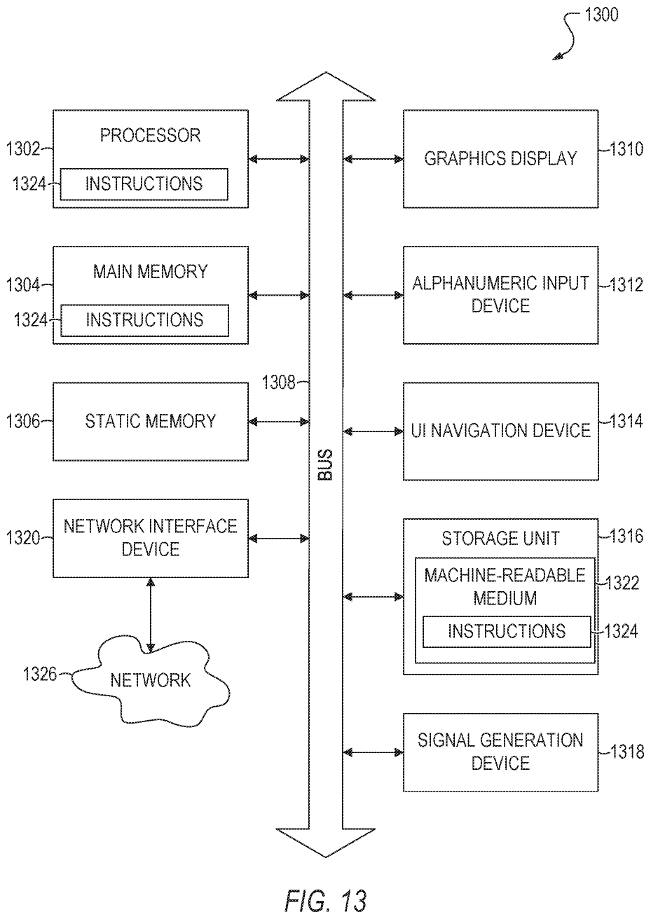

FIG. 13 is a block diagram of an example computer system 1300 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU), a graphics processing unit (GPU) or both), a main memory 1304 and a static memory 1306, which communicate with each other via a bus 1308. The computer system 1300 may further include a graphics display unit 1310 (e.g., a liquid crystal display (LCD) or a cathode ray tube (CRT)). The computer system 1300 also includes an alphanumeric input device 1312 (e.g., a keyboard or a touch-sensitive display screen), a user interface (UI) navigation device 1314 (e.g., a mouse), a storage unit 1316, a signal generation device 1318 (e.g., a speaker) and a network interface device 1320.

The storage unit 1316 includes a machine-readable medium 1322 on which is stored one or more sets of instructions and data structures (e.g., software) 1324 embodying or utilized by any one or more of the methodologies or functions described herein. The instructions 1324 may also reside, completely or at least partially, within the main memory 1304 and/or within the processor 1302 during execution thereof by the computer system 1300, the main memory 1304 and the processor 1302 also constituting machine-readable media.

While the machine-readable medium 1322 is shown in an example embodiment to be a single medium, the term “machine-readable medium” may include a single medium or multiple media (e.g., a centralized or distributed database, and/or associated caches and servers) that store the one or more instructions 1324 or data structures. The term “machine-readable medium” shall also be taken to include any tangible medium that is capable of storing, encoding or carrying instructions (e.g., instructions 1324) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The instructions 1324 may further be transmitted or received over a communications network 1326 using a transmission medium. The instructions 1324 may be transmitted using the network interface device 1320 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

The following numbered examples are embodiments.
1. A computer-implemented method comprising:
   determining, by a computer system having at least one hardware processor, that a plurality of online job postings published on an online service belong to a cohort based on the plurality of online job postings each having at least one particular attribute of the cohort;
   identifying, by the computer system, a plurality of skills from the plurality of online job postings, each one of the plurality of skills being included in at least one of the plurality of online job postings;
   determining, by the computer system, that a user of the online service belongs to the cohort based on a determination that a profile of the user stored in a database of the online service includes the at least one particular attribute of the cohort;
   determining, by the computer system, that one or more of the plurality of skills is stored in association with the profile of the user in the database of the online service;
   for each one of the one or more of the plurality of skills, determining, by the computer system, a corresponding user confidence score that indicates a level of relevance of the skill to the user;
   for each one of the one or more of the plurality of skills, determining, by the computer system, a corresponding cohort confidence score based on a corresponding number of the plurality of online job postings in which the skill is included; and
   causing, by the computer system, a recommendation associated with the user to be displayed within a user interface on a computing device based on a corresponding combination of the corresponding user confidence score and the corresponding cohort confidence score for each one of at least a portion of the one or more of the plurality of skills.
2. The computer-implemented method of example 1, wherein the at least one particular attribute of the cohort comprises at least two particular attributes.
3. The computer-implemented method of example 1 or example 2, wherein the at least one particular attribute of the cohort comprises a particular position title and a particular industry.
4. The computer-implemented method of any one of examples 1 to 3, wherein the determining the corresponding user confidence score for each one of the one or more of the plurality of skills comprises retrieving the corresponding user confidence score for each one of the one or more of the plurality of skills from the database of the online service.
5. The computer-implemented method of example 4, further comprising:
   analyzing, by the computer system, the profile of the user;
   generating, by the computer system, the corresponding user confidence score for each one of the one or more of the plurality of skills based on the analyzing of the profile of the user; and storing, by the computer system, the corresponding user confidence score for each one of the one or more of the plurality of skills in the database of the online service in association with the profile of the user.
6. The computer-implemented method of any one of examples 1 to 5, wherein the corresponding combination of the corresponding user confidence score and the corresponding cohort confidence score for each one of the at least a portion of the one or more of the plurality of skills comprises a corresponding multiplication product of the corresponding user confidence score and the corresponding cohort confidence score.
7. The computer-implemented method of any one of examples 1 to 6, further comprising storing, by the computer system, the corresponding user confidence score and the corresponding cohort confidence score for each one of the at least a portion of the one or more of the plurality of skills in association with the profile of the user in the database of the online service, wherein the causing the recommendation to be displayed comprises:
   determining that the recommendation corresponds to the cohort based on the recommendation having the at least one particular attribute of the cohort;
   retrieving the corresponding user confidence score and the corresponding cohort confidence score for each one of the at least a portion of the one or more of the plurality of skills based on the determining that the recommendation corresponds to the cohort;
   calculating a recommendation score for the recommendation based on the corresponding combination of the retrieved corresponding user confidence score and the retrieved corresponding cohort confidence score for each one of the at least a portion of the one or more of the plurality of skills; and
   causing the recommendation to be displayed based on the recommendation score.
8. The computer-implemented method of any one of examples 1 to 7, wherein the causing the recommendation to be displayed comprises calculating a recommendation score for the recommendation based on the corresponding combination for each one of the at least a portion of the one or more of the plurality of skills, a remaining portion of the one or more of the plurality of skills other than the at least a portion of the one or more of the plurality of skills being omitted from the calculating of the recommendation score based on the corresponding combination for each skill in the remaining portion not satisfying a threshold value.
9. The computer-implemented method of any one of examples 1 to 8, wherein:
   the recommendation comprises a job recommendation of another online job posting published on the online service;
   the causing the recommendation to be displayed comprises determining that the other online job posting belongs to the cohort based on the other online job posting having the at least one particular attribute of the cohort; and
   the job recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.
10. The computer-implemented method of any one of examples 1 to 9, wherein:
   the recommendation comprises a course recommendation of an online course published on the online service;
   the causing the recommendation to be displayed comprises determining that the online course belongs to the cohort based on the online course having the at least one particular attribute of the cohort; and
   the course recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the online course belongs to the cohort.
11. The computer-implemented method of any one of examples 1 to 10, wherein:
   the recommendation comprises a candidate recommendation for another online job posting published on the online service;
   the causing the recommendation to be displayed comprises determining that the other online job posting belongs to the cohort based on the other online job posting having the at least one particular attribute of the cohort; and
   the candidate recommendation is caused to be displayed on a computing device of a recruiter for the other online job posting based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.
12. A system comprising:
   at least one processor; and
   a non-transitory computer-readable medium storing executable instructions that, when executed, cause the at least one processor to perform the method of any one of examples 1 to 11.
13. A non-transitory machine-readable storage medium, tangibly embodying a set of instructions that, when executed by at least one processor, causes the at least one processor to perform the method of any one of examples 1 to 11.
14. A machine-readable medium carrying a set of instructions that, when executed by at least one processor, causes the at least one processor to carry out the method of any one of examples 1 to 11.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining, by a computer system having at least one hardware processor, that a plurality of online job postings published on an online service belong to a cohort based on the plurality of online job postings each having at least one particular attribute of the cohort;
identifying, by the computer system, a plurality of skills from the plurality of online job postings, each one of the plurality of skills being included in at least one of the plurality of online job postings;
determining, by the computer system, that a user of the online service belongs to the cohort based on a determination that a profile of the user stored in a database of the online service includes the at least one particular attribute of the cohort;
determining, by the computer system, that one or more of the plurality of skills is stored in association with the profile of the user in the database of the online service;
for each one of the one or more of the plurality of skills, determining, by the computer system, a corresponding user confidence score that indicates a level of relevance of the skill to the user;
for each one of the one or more of the plurality of skills, determining, by the computer system, a corresponding cohort confidence score based on a corresponding number of the plurality of online job postings in which the skill is included; and
causing, by the computer system, a recommendation associated with the user to be displayed within a user interface on a computing device based on a corresponding combination of the corresponding user confidence score and the corresponding cohort confidence score for each one of at least a portion of the one or more of the plurality of skills.

2. The computer-implemented method of claim 1, wherein the at least one particular attribute of the cohort comprises at least two particular attributes.

3. The computer-implemented method of claim 2, wherein the at least two particular attributes of the cohort comprise a particular position title and a particular industry.

4. The computer-implemented method of claim 1, wherein the determining the corresponding user confidence score for each one of the one or more of the plurality of skills comprises retrieving the corresponding user confidence score for each one of the one or more of the plurality of skills from the database of the online service.

5. The computer-implemented method of claim 4, further comprising:
analyzing, by the computer system, the profile of the user;
generating, by the computer system, the corresponding user confidence score for each one of the one or more of the plurality of skills based on the analyzing of the profile of the user; and
storing, by the computer system, the corresponding user confidence score for each one of the one or more of the plurality of skills in the database of the online service in association with the profile of the user.

6. The computer-implemented method of claim 1, wherein the corresponding combination of the corresponding user confidence score and the corresponding cohort confidence score for each one of the at least a portion of the one or more of the plurality of skills comprises a corresponding multiplication product of the corresponding user confidence score and the corresponding cohort confidence score.

7. The computer-implemented method of claim 1, further comprising storing, by the computer system, the corresponding user confidence score and the corresponding cohort confidence score for each one of the at least a portion of the one or more of the plurality of skills in association with the profile of the user in the database of the online service, wherein the causing the recommendation to be displayed comprises:
determining that the recommendation corresponds to the cohort based on the recommendation having the at least one particular attribute of the cohort;
retrieving the corresponding user confidence score and the corresponding cohort confidence score for each one of the at least a portion of the one or more of the plurality of skills based on the determining that the recommendation corresponds to the cohort;
calculating a recommendation score for the recommendation based on the corresponding combination of the retrieved corresponding user confidence score and the retrieved corresponding cohort confidence score for each one of the at least a portion of the one or more of the plurality of skills; and
causing the recommendation to be displayed based on the recommendation score.

8. The computer-implemented method of claim 1, wherein the causing the recommendation to be displayed comprises calculating a recommendation score for the recommendation based on the corresponding combination for each one of the at least a portion of the one or more of the plurality of skills, a remaining portion of the one or more of the plurality of skills other than the at least a portion of the one or more of the plurality of skills being omitted from the calculating of the recommendation score based on the corresponding combination for each skill in the remaining portion not satisfying a threshold value.

9. The computer-implemented method of claim 1, wherein:
the recommendation comprises a job recommendation of another online job posting published on the online service;
the causing the recommendation to be displayed comprises determining that the other online job posting belongs to the cohort based on the other online job posting having the at least one particular attribute of the cohort; and
the job recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.

10. The computer-implemented method of claim 1, wherein:
the recommendation comprises a course recommendation of an online course published on the online service;
the causing the recommendation to be displayed comprises determining that the online course belongs to the cohort based on the online course having the at least one particular attribute of the cohort; and
the course recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the online course belongs to the cohort.

11. The computer-implemented method of claim 1, wherein:
the recommendation comprises a candidate recommendation for another online job posting published on the online service;
the causing the recommendation to be displayed comprises determining that the other online job posting belongs to the cohort based on the other online job posting having the at least one particular attribute of the cohort; and
the candidate recommendation is caused to be displayed on a computing device of a recruiter for the other online job posting based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.

12. A system comprising:
at least one hardware processor; and
a non-transitory machine-readable medium embodying a set of instructions that, when executed by the at least one hardware processor, cause the at least one processor to perform operations, the operations comprising:
determining that a plurality of online job postings published on an online service belong to a cohort based on the plurality of online job postings each having at least one particular attribute of the cohort;
identifying a plurality of skills from the plurality of online job postings, each one of the plurality of skills being included in at least one of the plurality of online job postings;
determining that a user of the online service belongs to the cohort based on a determination that a profile of the user stored in a database of the online service includes the at least one particular attribute of the cohort;
determining that one or more of the plurality of skills is stored in association with the profile of the user in the database of the online service;
for each one of the one or more of the plurality of skills, determining a corresponding user confidence score that indicates a level of relevance of the skill to the user;
for each one of the one or more of the plurality of skills, determining a corresponding cohort confidence score based on a corresponding number of the plurality of online job postings in which the skill is included; and
causing a recommendation associated with the user to be displayed within a user interface on a computing device based on a corresponding combination of the corresponding user confidence score and the corresponding cohort confidence score for each one of at least a portion of the one or more of the plurality of skills.

13. The system of claim 12, wherein the at least one particular attribute of the cohort comprises a particular position title and a particular industry.

14. The system of claim 12, wherein the determining the corresponding user confidence score for each one of the one or more of the plurality of skills comprises retrieving the corresponding user confidence score for each one of the one or more of the plurality of skills from the database of the online service.

15. The system of claim 12, wherein the operations further comprise storing the corresponding user confidence score and the corresponding cohort confidence score for each one of the at least a portion of the one or more of the plurality of skills in association with the profile of the user in the database of the online service, wherein the causing the recommendation to be displayed comprises:
determining that the recommendation corresponds to the cohort based on the recommendation having the at least one particular attribute of the cohort;
retrieving the corresponding user confidence score and the corresponding cohort confidence score for each one of the at least a portion of the one or more of the plurality of skills based on the determining that the recommendation corresponds to the cohort;
calculating a recommendation score for the recommendation based on the corresponding combination of the retrieved corresponding user confidence score and the retrieved corresponding cohort confidence score for each one of the at least a portion of the one or more of the plurality of skills; and
causing the recommendation to be displayed based on the recommendation score.

16. The system of claim 12, wherein the causing the recommendation to be displayed comprises calculating a recommendation score for the recommendation based on the corresponding combination for each one of the at least a portion of the one or more of the plurality of skills, a remaining portion of the one or more of the plurality of skills other than the at least a portion of the one or more of the plurality of skills being omitted from the calculating of the recommendation score based on the corresponding combination for each skill in the remaining portion not satisfying a threshold value.

17. The system of claim 12, wherein:
the recommendation comprises a job recommendation of another online job posting published on the online service;
the causing the recommendation to be displayed comprises determining that the other online job posting belongs to the cohort based on the other online job posting having the at least one particular attribute of the cohort; and
the job recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.

18. The system of claim 12, wherein:
the recommendation comprises a course recommendation of an online course published on the online service;
the causing the recommendation to be displayed comprises determining that the online course belongs to the cohort based on the online course having the at least one particular attribute of the cohort; and
the course recommendation is caused to be displayed on a computing device of the user based on the corresponding combination of the corresponding user confidence score and the corresponding cohort confidence score for each one of the at least a portion of the one or more of the plurality of skills, the corresponding cohort confidence scores being used in the corresponding combinations based on the determining that the online course belongs to the cohort.

19. The system of claim 12, wherein:
the recommendation comprises a candidate recommendation for another online job posting published on the online service;
the causing the recommendation to be displayed comprises determining that the other online job posting belongs to the cohort based on the other online job posting having the at least one particular attribute of the cohort; and
the candidate recommendation is caused to be displayed on a computing device of a recruiter for the other online job posting based on the corresponding combination of the corresponding user confidence score and the corresponding cohort confidence score for each one of the at least a portion of the one or more of the plurality of skills, the corresponding cohort confidence scores being used in the corresponding combinations based on the determining that the other online job posting belongs to the cohort.

20. A non-transitory machine-readable medium embodying a set of instructions that, when executed by at least one hardware processor, cause the processor to perform operations, the operations comprising:
determining that a plurality of online job postings published on an online service belong to a cohort based on the plurality of online job postings each having at least one particular attribute of the cohort;
identifying a plurality of skills from the plurality of online job postings, each one of the plurality of skills being included in at least one of the plurality of online job postings;
determining that a user of the online service belongs to the cohort based on a determination that a profile of the user stored in a database of the online service includes the at least one particular attribute of the cohort;
determining that one or more of the plurality of skills is stored in association with the profile of the user in the database of the online service;
for each one of the one or more of the plurality of skills, determining a corresponding user confidence score that indicates a level of relevance of the skill to the user;
for each one of the one or more of the plurality of skills, determining a corresponding cohort confidence score based on a corresponding number of the plurality of online job postings in which the skill is included; and
causing a recommendation associated with the user to be displayed within a user interface on a computing device based on a corresponding combination of the corresponding user confidence score and the corresponding cohort confidence score for each one of at least a portion of the one or more of the plurality of skills.
